(19) United States
(12) Patent Application Publication
(10) Pub. No.: US 2006/0149689 A1
(43) Pub. Date: Jul. 6, 2006

(54) Automated media verification and price polling

(76) Inventor: Michael K. DuKane, Woodinville, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/274,754

(22) Filed: Nov. 14, 2005

Related U.S. Application Data
(60) Provisional application No. 60/627,359, filed on Nov. 12, 2004.

(51) Int. Cl. G06Q 99/00; G06F 17/00

(52) U.S. Cl. 705/400; 705/1

(57) ABSTRACT

In a computer system, an identification of media content stored on a medium is determined. The identification is provided to a first electronic device, such as a server. A price at which the medium storing the media content may be sold is received from the first electronic device.

### CROSS REFERENCE To RELATED APPLICATION

The present application claims priority from U.S. Provisional Application 60/627,359, filed Nov. 12, 2004, which is incorporated herein by reference.

### BACKGROUND

An embodiment of the invention pertains to the field of computer networking, and more particularly to the use of network protocols linking a local computer system to a database connected via a network to provide services that identify the real-time market value of an audio recording, visual (e.g., video) recording or other media content fixed to a medium such as compact discs (CDs), digital versatile discs (DVDs), videotapes, audio tapes and/or other physical storage media. For convenience, the term “CD” as used herein refers to any fixed-media content, including, for example, CDs, DVDs, videotapes and audio tapes.

Since the introduction of the Internet, on-line music stores have experienced explosive growth and have become a major form of Internet E-commerce for the purchase of audio recordings (e.g., music CDs). In addition to the sales growth of on-line music CDs is the significant growth of consumer Internet buying and selling of used music CDs. In the past few years, retailers have begun to buy and sell used music CDs in addition to newly released music CDs.

The current process of selling a used CD requires a prospective seller to access a retailer's on-line store via a network using, for example, an Internet browser. The seller must then enter the title of the music CD they desire to sell into a search field generated by the server hosting the on-line store and search the retailer's on-line database for the CD title. Once located, if at all, the retailer would offer a price quote to the seller for the CD title the seller owns via the retailer's web page. The seller has the option of then selling the CD title to the retailer by clicking a button on the retailer's web page. To obtain multiple price quotes from other retailers, the seller is required to access each retailer's on-line store individually and perform similar steps.

In addition, once a sale is tentatively consummated, the seller must package the CD title to be sold and ship it to the retailer. This may be true even if the retailer has a physical store in the same locale as the seller. Once the retailer receives the CD, the retailer must then scan the data on the CD to ensure its good working order. If the CD fails the scan, then the transaction is canceled. The retailer may or may not return the CD to the seller if it fails the scan test. If the seller requests return of the CD, the seller typically must pay shipping and handling to receive the failed CD.

Currently, there are various methods used to identify a CD title via a network. Common to these processes is use of the table of contents (TOC) of a CD title which is read when the CD is placed into a computer's CD tray. While embodiments of the present invention may incorporate these methods as a matter of convenience, such embodiments are not reliant on these methods.

### SUMMARY

According to an embodiment of the invention, in a computer system, an identification of media content stored on a medium is determined. The identification is provided to a first electronic device, such as a server. A price at which the medium storing the media content may be sold is received from the first electronic device.

### BRIEF DESCRIPTION OF THE DRAWINGS

FIG. 1 is a schematic view of an exemplary operating environment in which an embodiment of the invention can be implemented;

FIG. 2 is a functional block diagram of a system according to an embodiment of the invention;

FIG. 3 is a schematic block diagram of a system according to an embodiment of the invention;

FIG. 4 is a flow diagram illustrating a first method according to an embodiment of the invention; and

FIG. 5 is a flow diagram illustrating a second method according to an embodiment of the invention.

### DETAILED DESCRIPTION

Embodiments of this invention include computer programs, systems, and protocols that allow a seller to obtain a real time valuation for their CD title from those retailers who desire to buy the CD title from the seller. The computer programs, systems, and protocols also allow for the storage, retrieval and consummation of the on-line buy/sell transaction between the seller and the retailer. In an embodiment of the invention, the seller's computer will scan the CD data tracks while the CD is in the seller's computer to determine the readability of all data sectors on the CD. Embodiments of the invention achieve the foregoing by means of implementations designed to attain integration with existing environments and programs, particularly on the Internet, while retaining the flexibility to adapt to the continuing evolution of standards for on-line services.

In an embodiment, software is provided that permits a seller's computer to identify a CD title placed into the CD tray of the seller's computer. The software is designed to permit the seller's computer to access a remote host computer via a network to retrieve an identification, such as the Universal Product Code (UPC) or publisher's catalog number (CID) of such CD title. The initial identification of the CD title is achieved by identifying the TOC of the CD placed in the tray and matching the TOC with a database containing the UPC or CID for that CD title.

In an alternative embodiment, the seller enters the UPC or CID of the CD title into a field generated by the software.

In an alternative embodiment, the seller enters any information which is contained on the CD title into a field generated by the software and retrieves a narrow selection of matches from the remote database, which allows the seller to choose the specific match.

In an embodiment, the provided software connects via TCP/IP or other network protocol to the databases of one or more servers of retailers willing to buy the CD title. The software uses the UPC or CID as a means of matching to a retailer's database of CD inventory to obtain the current offering price from each retailer. The software then presents to the seller each retailer's identity and their respective offering price for the specific CD title. The seller can then choose the desired retailer and reserve the CD title as a pending sales transaction with the retailer.

In an embodiment, the software offers the seller an option to evaluate the quality of the CD while it is in the seller's computer tray. Under this evaluation, the software may cause the seller's CD drive to scan the data blocks on the CD. The data scan examines each data block on the CD to determine if a specific block of data can be read without failure. If a particular block cannot be read, the software notifies the seller of its failure to read a data block. The seller can clean the CD and try the scan again. If the CD passes the scan test, then the software creates a certification ID and adds the certification ID to the sales transaction. This provides the retailer with evidence of the scan and certifies the quality of the CD being sold.

In an embodiment, the software stores a record of the pending transaction on the seller's computer as well as on the retailer's server. The software aggregates all transactions related to a particular buyer into a summary of value to be received by the seller from that buyer. The software contemplates that the seller may have multiple transactions relating to multiple CD titles with multiple buyers.

In an embodiment, the software consummates the transaction by transferring the value to the appropriate retailer's customer database under a unique account number representing the seller's identity along with an itemization of CD titles to be purchased by a retailer including, but not limited to, the CD title, UPC, CID and the value to be received by the seller upon consummation of the transaction. The software assigns a unique identifier of the transaction and notifies the seller of the account value to be received upon consummation of the transaction. The software may then connect the seller to the retailer's on-line store via a web browser or allow the seller to print a transaction verification document via the seller's printer. The document identifies the details of the transaction along with, for example, bar code identification. The retailer may give the seller an option to redeem the value of the transaction at any of the retailer's physical locations.

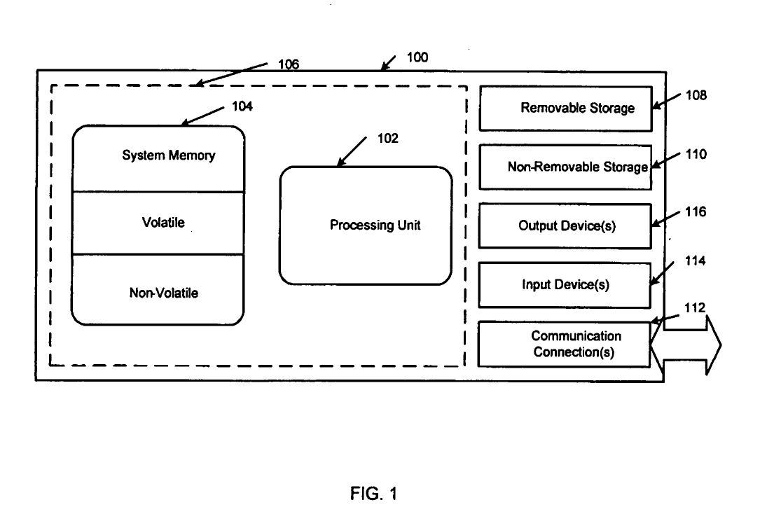

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a computing device, such as computing device 100. In its most basic configuration, computing device 100 typically includes at least one processing unit 102 and memory 104.

Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 may also contain communications connection(s) 112 that allow the device to communicate with other devices. Communications connection(s) 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both storage media and communication media.

Device 100 may also have input device(s) 114 such as keyboard, mouse, pen, voice input device, touch input device, CD drive, etc. Output device(s) 116 such as a display, speakers, printer, etc. may also be included. All these devices are well know in the art and need not be discussed at length here.

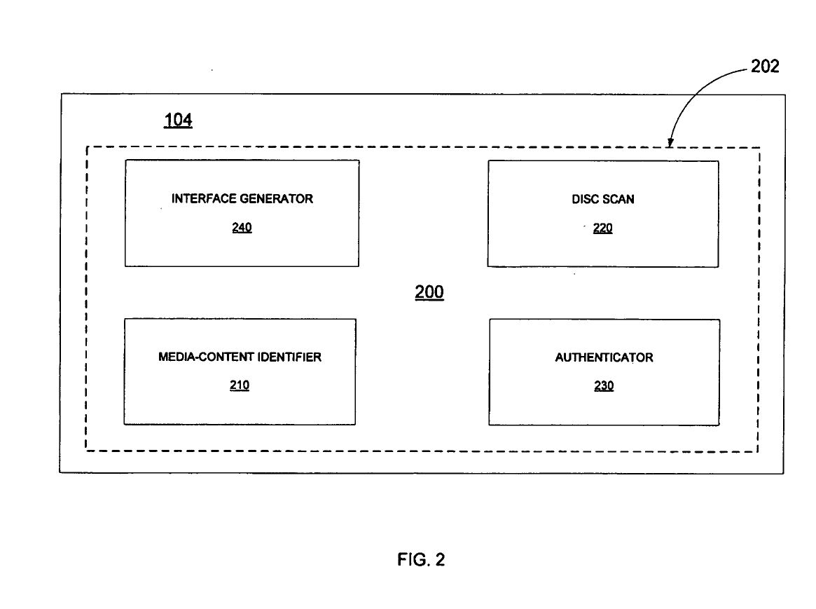

FIG. 2 illustrates a system 200 according to an embodiment of the invention and delineated by a dashed line 202. In an embodiment, the system 200 includes a media-content identifier module 210, a disc-scan module 220, an authenticator module 230, and an interface-generator module 240, each of which is stored in the memory 104 and executable by the processing unit 102. The functionality of the system 200 is discussed in greater detail below.

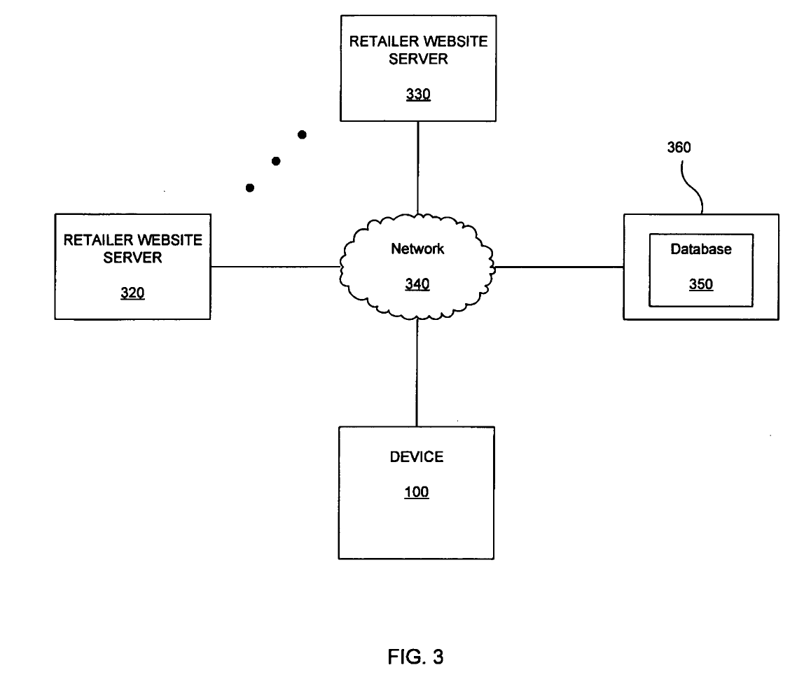

Referring to FIG. 3, and in operation according to an embodiment of the invention, a seller (not shown) inserts into the seller's computer, such as, for example, the device 100, an audio CD (not shown) that the seller may wish to sell to a retailer having an online presence. The device 100, employing, for example, the media-content identifier module 210, is operable to read from the CD information, such as a TOC, corresponding to the media content stored on the CD. The device 100 may then access, via a network 340 such as the Internet, an audio-CD-identification database 350 associated with an electronic device 360, such as a server, to determine an identification, such as the UPC, of such CD title. In an embodiment, if the CD title was published in more than one edition with some difference in content between editions, the database 350 also returns to the device 100 a data set that can be displayed on a display (not shown) by the device 100 to distinguish one edition from another and allow the seller to select the appropriate identifier for that edition. Alternatively, the interface generator 240 is operable to generate to a display a field within which the seller can enter the UPC of the CD title for processing by the system 200 as discussed in further detail below. Alternatively still, the audio-CD-identification database may be stored on the device 100 or on another electronic device directly coupled to (i.e., not remote from) the device 100.

In an embodiment, before, during or after the media-content identification is obtained from the database 350, the disc-scan module 220, in conjunction with a CD drive (not shown) of the device 100, performs a scan of the CD to determine whether all of its data is readable so that the CD can be sold as non-defective. If the disc is non-defective, the authenticator module 230 generates a secure authentication certificate using any of many known authentication methods in communication with an authentication server, which, in an embodiment, is the server 360 associated with the database 350.

Once the disc has been identified and scanned for defects, the device 100 provides the UPC and authentication certificate, via the network 340, to at least one electronic device, such as retailer web-site servers 320, 330. In an embodiment, the servers 320, 330 are remote from the device 100 in at least the sense that the servers and device communicate via at least one electronic device, such as, for example, a computer associated with the network 340. Although only two such servers 320, 330 are illustrated in FIG. 3, it should be recognized that embodiments of the invention may be implemented using more or fewer such servers. The authentication certificate, which certifies that the disc is non-defective, is provided by the device 100 to each of the servers 320, 330. The servers 320, 330 may then communicate with the authentication server to verify information in the authentication certificate. Each of the servers 320, 330 then provides to the device 100 a price that a corresponding retailer is willing to pay, if any, to buy the identified CD.

The system 200 makes requests of the servers 320, 330 by means of uniform resource locators (URLs). A URL includes both an identification of the server and an identification of a particular item of data within the server that the software wants to retrieve. The URLs for the servers 320, 330 may be obtained by the device 100 from an update server, which, in an embodiment, is the server 360 associated with the database 350 and which provides an updated list of retailer servers to be polled.

Once the offering prices are obtained from the servers 320, 330, the interface generator 240 may generate to a display a user-interface window (not shown) that presents the pricing information to the seller. In an embodiment, only the highest price offered by a retailer is presented. Alternatively, the offers from other servers, if any, are presented, as well.

If the seller elects to sell the CD, the seller may add the CD to a field (not shown) of a user interface listing CDs to be sold to a particular retailer. A separate such list may be maintained for each retailer, and the total offer from each retailer may also be displayed. The seller can then move, in a conventional manner, a title from one retailer's list to another and observe how the amount of money to be received changes. By this process, the seller can decide to sell a plurality of CDs to a single retailer to simplify the transaction or reduce shipping costs.

In an embodiment, the content portion of the responses received from the servers 320, 330 and displayed by the device can be text interspersed with bitmap-format images and links (also known as anchors and hyper links). The links can be URLs to which the system 200 may, at the seller's prompting, send further requests to the servers 320, 330. While the system 200 can address each server 320, 330 with compiled code contained within the system 200, the system 200 can also use external code written in a common scripting language such as Javascript, Applescript or VBscript. It is also possible to execute this function of the system 200 with external compiled code. Such external compiled code is referred to as a “plug-in.” The precise protocol for writing a plug-in is dependent on the particular operating system the system 200 is implemented in, such as Microsoft Windows® or Apple OS X. Such Plug-ins may be designed to address only one network server or many servers to obtain the CD value information.

An embodiment of the invention employs a plug-in, referred to as the access plug-in, which provides to a scripting language the ability to connect with specific protocols to a network server with specific authorizations for access. The access plug-in should provide, at a minimum, the following basic functions:

The identity of the seller.

The identity of each CD title by UPC or CID.

The access key which authorizes the seller's computer to access the retailer's server.

The transaction ID and all relative transaction data.

Other functions may be provided, limited only by what the underlying operating system services are able to provide.

The access plug-in is preferably written in a conventional programming language such as C++. The plug in must conform to the existing standards for plug-ins, such as those required of Microsoft ActiveX objects. Given the above summary of the functions which the access plug-in provides, a general knowledge of how to write plug-ins (e.g., of how to write ActiveX objects), and a knowledge of the relevant application interfaces for accessing a server over a network, a person skilled in the art could readily and without undue experimentation develop an actual working access plug-in. For this reason, further details of how the access plug-in is implemented are not provided here.

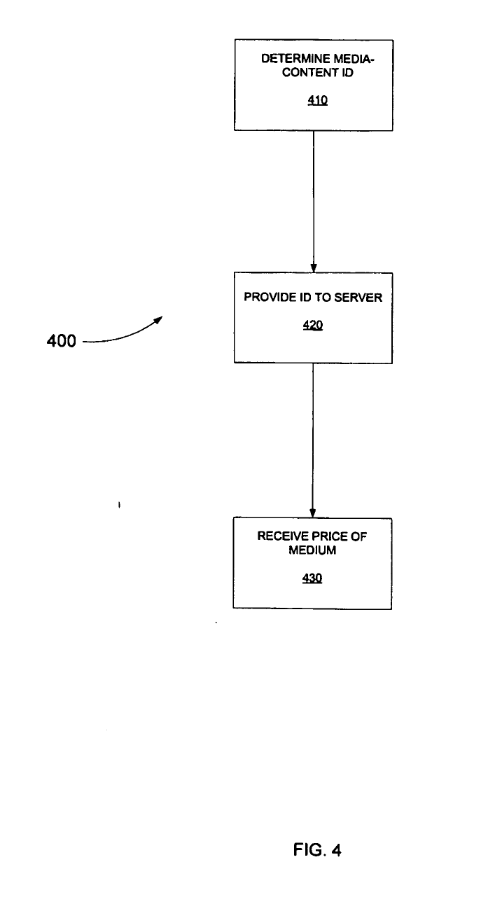

FIG. 4 illustrates an automated process 400 for receiving an offer to purchase, and/or terms thereof, a CD according to an embodiment of the invention. The process 400 is illustrated as a set of operations shown as discrete blocks. The process 400 may be implemented in any suitable hardware, software, firmware, or combination thereof. The order in which the operations are described is not to be necessarily construed as a limitation.

At a block 410, the device 100, implementing the system 200, determines an identification, such as the UPC, of media content stored on a medium, such as a CD. For example, the device 100 may access, via the network 340, an audio-CD-identification database 350 to determine the identification. Alternatively, the interface generator 240 is operable to generate to a display a field within which the seller can enter the UPC of the CD title for processing by the system 200 as discussed in detail above.

At a block 420, the device 100 provides the identification to a first electronic device. For example, the device 100 provides the UPC, via the network 340, to at least one retailer web-site server 320, 330.

At a block 430, the device 100 receives from the first electronic device a price at which the medium storing the media content may be sold. For example, each of the servers 320, 330, in response to receiving the UPC, provides to the device 100 a price that a corresponding retailer is willing to pay, if any, to buy the identified CD.

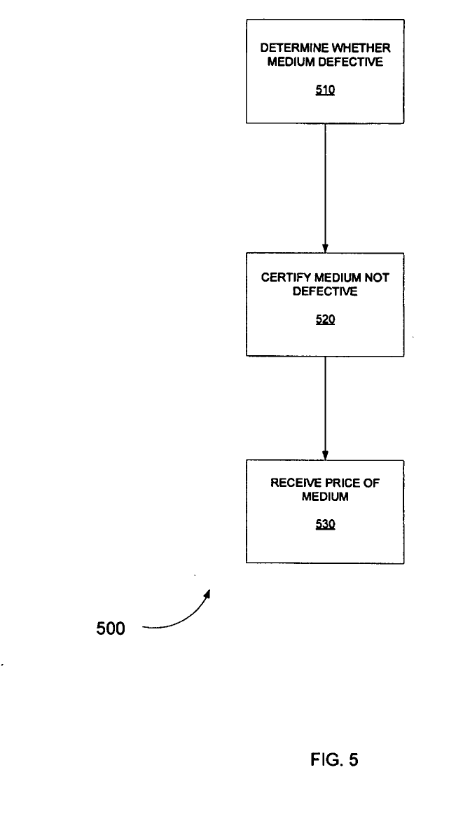

FIG. 5 illustrates an automated process 500 for receiving an offer to purchase, and/or terms thereof, a CD according to an embodiment of the invention. The process 500 is illustrated as a set of operations shown as discrete blocks. The process 500 may be implemented in any suitable hardware, software, firmware, or combination thereof. The order in which the operations are described is not to be necessarily construed as a limitation.

At a block 510, the system 200 implemented in the device 100 determines whether a CD storing media content is defective. For example, the disc-scan module 220, in conjunction with a CD drive of the device 100, performs a scan of the CD to determine whether all of its data is readable so that the CD can be sold as non-defective.

At a block 520, if the disc is non-defective, the device 100 certifies to a first electronic device that the CD is not defective. For example, the authenticator module 230 may generate a secure authentication certificate using any of many known authentication methods in communication with an authentication server and provide the authentication certificate, via the network 340, to at least one retailer web-site server 320, 330.

At a block 530, the device 100 receives from the first electronic device a price at which the certified medium may be sold. For example, each of the servers 320, 330, in response to receiving the certificate, provides to the device 100 a price that a corresponding retailer is willing to pay, if any, to buy the certified CD.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. An article of manufacture, comprising: a computer-readable medium having computer-executable instructions embodied thereon to:
determine an identification of media content stored on a medium;
provide the identification to a first electronic device; and
receive from the first electronic device a price at which the medium storing the media content may be sold.

2. The article of claim 1 wherein the media content comprises audio content.

3. The article of claim 1 wherein the first electronic device is remote from the computer system.

4. The article of claim 1 wherein the identification comprises a UPC.

5. The article of claim 1 having further computer-executable instructions embodied thereon to determine whether the medium is defective.

6. The article of claim 1 wherein determining the identification comprises determining a table of contents (TOC) of the media content.

7. The article of claim 6 wherein determining the identification further comprises providing the TOC to a second electronic device.

8. The article of claim 7, wherein determining the identification further comprises receiving the identification from the second electronic device.

9. An article of manufacture, comprising: a computer-readable medium having computer-executable instructions embodied thereon to:
determine whether a medium storing media content is defective;
if the medium is not defective, certify to a first electronic device that the medium is not defective; and
receive from the first electronic device a price at which the certified medium may be sold.

10. In a computer system, a method comprising:
determining an identification of media content stored on a medium;
providing the identification to a first electronic device; and
receiving from the first electronic device a price at which the medium storing the media content may be sold.
